(19) United States
(12) Patent Application Publication
(10) Pub. No.: US 2026/0138229 A1
(43) Pub. Date: May 21, 2026

(54) Braking method for power tools

(71) Applicant: Hilti Aktiengesellschaft, Schaan (LI)

(72) Inventors: Markus SCHERBAUM, Gennach (DE); Venkataramana Chowdary PAMULAPATI, Geltendorf (DE)

(21) Appl. No.: 19/363,931

(22) Filed: Oct. 21, 2025

(30) Foreign Application Priority Data
Nov. 18, 2024 (EP) 24213514.3

(51) Int. Cl. B24B 27/06; B24B 27/08; H02P 3/06; H02P 23/14

(52) U.S. Cl. CPC B24B 27/0675; B24B 27/08; H02P 3/06; H02P 23/14

(57) ABSTRACT

A method for braking a power tool, wherein the power tool has a motor which is connected to an output shaft via a belt drive, wherein the method includes the following steps: a) applying or maintaining a braking torque, acting on the motor, for a first period of time; b) reducing the braking torque for a second period of time; c) increasing or maintaining the braking torque for a third period of time.

This claims priority to European Patent Application EP 24213514.3, filed on November 18, 2024 which is hereby incorporated by reference herein.

The present invention relates to a method for braking power tools, in particular, but not exclusively, for braking cut-off or cutting devices. Further aspects of the present invention relate to a power tool for carrying out the method and to a computer program for the method to be carried out by a computer.

### BACKGROUND

Electrically operated power tools generally have an electric motor, which is connected to the tool via a gear mechanism. The gear mechanism plays a central part in force transmission, speed control and adaptation of the torque. Power tools such as drills or cut-off grinders use gear mechanisms in order to convert the movement of the motor into a controlled movement of the tool. There are a large number of types of gear mechanisms, which are each used for different types of power tool. Depending on the field of application and the forces and speeds to be transmitted, different kinds of gear mechanisms are used.

For example, a belt drive is frequently used in cut-off grinders. In this case, the force of the motor is transmitted to the grinding disc via a belt (for example a flat belt or toothed belt), rather than via a direct mechanical coupling by way of gearwheels or chains. The gear mechanism having a belt drive consists substantially of pulleys and the belt itself, which jointly control the transmission ratio and thus the speed and torque of the grinding disc. Belt drives provide a high level of flexibility and running smoothness, but frequently also require more maintenance than direct gearwheel systems.

### SUMMARY OF THE INVENTION

In the field of power tools, it is also known practice to slow down the tools of the power tools in order to finish work or for safety reasons. Various braking methods are known from the prior art. It has been found, however, that, especially when use is made of power tools with belt drives, insufficient transmission of the torque from the motor to the tool frequently occurs, and so, under certain circumstances, the motor comes to a standstill long before the tool does. However, it is important especially to slow down the tool as quickly as possible in order to reduce the health risks for the user to a minimum.

On the basis of the abovementioned problem, it is an object of the present invention to specify a method for braking a power tool, by way of which slip of the belt during braking can be reduced and the motor and the tool come to a standstill preferably at the same time or substantially at the same time.

Accordingly, the present invention relates to a method for braking a power tool, wherein the power tool has a motor which is connected to an output shaft via a belt drive, wherein the method comprises the following steps:

a) increasing or maintaining a braking torque, acting on the motor, for a first period of time;

b) reducing the braking torque for a second period of time;

c) increasing or maintaining the braking torque for a third period of time.

In belt drives, the maximum torque to be transmitted depends greatly on the pretension of the belt and on the friction between the belt and the pulley. A worn belt loses its pretension, and a dirty and oily belt loses friction with the pulley, and so less torque can be transmitted in these case. In particular, as soon as the belt slips, it can transmit much less torque since the sliding friction is lower than the static friction. With regard to the braking operation of a power tool, this means that the motor can slow down to a standstill independently of the clamped tool when the belt slips. In this case, only the sliding friction of the output shaft ensures a braking torque which is lower than in the case of a belt that is not slipping. The braking time of the tool is thus increased.

As a result of the interim reduction in the torque, slipping (slip) of the drive belt can be effectively reduced. The reduction in the torque has the effect that the torque acting on the motor can be transmitted effectively to the output shaft even in the event of poor friction (for example a dirty or oily belt). As soon as the slip (i.e. slipping of the belt) has decreased, on account of the reduced torque, the braking torque can be increased again in order to bring the output shaft and thus the tool to a standstill as quickly as possible.

In other words, a basic concept of the present invention is to temporarily reduce the braking torque in order to prevent slipping of the belt or to counteract slipping. As a result, the braking time until the motor comes to a standstill is generally increased, but a shortening of the braking time until the tool comes to a standstill is achieved. In particular, in the method according to the invention, the motor and the tool come to a standstill at the same time. It should already be mentioned at this point that the second period of time can be very short (for example essentially zero), i.e. that the braking torque of the motor according to one embodiment variant (FIG. 3) is reduced abruptly (for example is set abruptly to zero) and is immediately increased again. In other embodiments, the braking torque is reduced over a longer time, i.e. the braking torque is reduced relatively slowly.

According to a further embodiment, the braking torque is achieved by way of a negative torque. The negative braking torque can be generated for example in that a brushless motor is actuated such that the motor current generates a braking torque.

According to a further embodiment, the braking torque is reduced when slip of the belt is established during the first period of time. Occurring slip can be established in several ways. For example, the slip can be sensed by comparing the motor speed with the speed of the tool. Alternatively or additionally, the negative acceleration (braking acceleration) of the motor can be used in order to sense slip. If the decrease in the motor speed and thus the negative acceleration is too high, it can be assumed that the braking torque is no longer being transmitted, or no longer being fully transmitted, to the tool and thus there is slip at the belt. This embodiment is not limited to the manner in which the slip of the belt is sensed.

According to a further embodiment, the method comprises a step of sensing motor speed data which are representative of a speed of the motor, wherein an end of the first period of time is determined on the basis of the motor speed data. The motor speed may be determined for example via a motor position sensor (Hall sensor, AMR sensor, etc.) or via sensor-free motor control methods.

According to a further embodiment, an end of the first and/or of the third period of time is reached when the speed of the motor is essentially zero.

According to a further embodiment, the second period of time is essentially zero. In other words, the braking torque is reduced abruptly according to this embodiment variant. For example, the braking torque can be set suddenly to zero when the end of the first period of time is reached. In this case, the expression “essentially zero” means that, although the target value of the braking torque is set abruptly to zero at the end of the first period of time, the actual value in reality requires a short time in order to drop to zero. According to this embodiment variant, the time required until the torque drops is the second period of time.

According to a further embodiment, after step c), steps b) and c) are repeated, in particular until the output shaft comes to a standstill. According to this embodiment, the method provides for the braking torque to be periodically reduced and increased again in order to minimize the time until the output shaft and thus the tool is at a standstill. As a result of the regular reducing and increasing of the braking torque, slip of the drive belt is kept low, but a braking torque that is as high as possible is still applied. As a result, the braking time until the tool is at a standstill is effectively reduced.

According to a further embodiment, the first, second and/or third time period are predetermined time intervals. These time intervals may be specified by the manufacturer.

According to a further embodiment, the method comprises the following further steps:

sensing motor speed data which are representative of a speed of the motor;

sensing/estimating output speed data which are representative of a speed of the output shaft;

determining the speed of the motor and the speed of the output shaft;

determining a slip value on the basis of the speed of the motor compared with the speed of the output shaft;

increasing or reducing the braking torque on the basis of the slip value.

The speed of the output shaft can be sensed via position sensors. The speed of the cutting disc is also a measure for the speed of the output shaft. The speed of the output shaft can also be estimated, for example from the maximum possible braking acceleration of the system made up of the cutting disc and motor.

According to a further embodiment, the length of the first, of the second and of the third time interval is adjusted such that the slip value falls in a predetermined range of values.

According to a further embodiment, the periods of time are adjusted such that the slip value is between 0% and 40%, preferably between 0% and 30%.

According to a further embodiment, the braking torque is maximized during the first period of time.

A further aspect of the present invention relates to a power tool having a motor and an output shaft driven via a belt drive, wherein the power tool has a control device which is designed to carry out the abovementioned method.

The power tool may be a cut-off grinder.

A further aspect of the present invention relates to a computer program comprising instructions which, when the program is executed by a computer, cause the latter to carry out the abovementioned method.

Further advantages will become apparent from the following description of the figures. The figures, the description and the claims contain numerous features in combination. A person skilled in the art will expediently also consider the features individually and combine them to form useful further combinations.

### BRIEF DESCRIPTION OF THE DRAWINGS

In the figures:

FIG. 1 shows a schematic illustration of the speed and torque over time during a braking operation without slip;

FIG. 2 shows a schematic illustration of the speed and torque over time during a braking operation with slip;

FIG. 3 shows a schematic illustration of the speed and torque over time during a braking operation according to one embodiment of the present invention;

FIG. 4 shows a schematic illustration of the speed and torque over time during a braking operation according to one embodiment of the present invention; and

FIG. 5 shows schematically a cut-off grinder.

### DETAILED DESCRIPTION

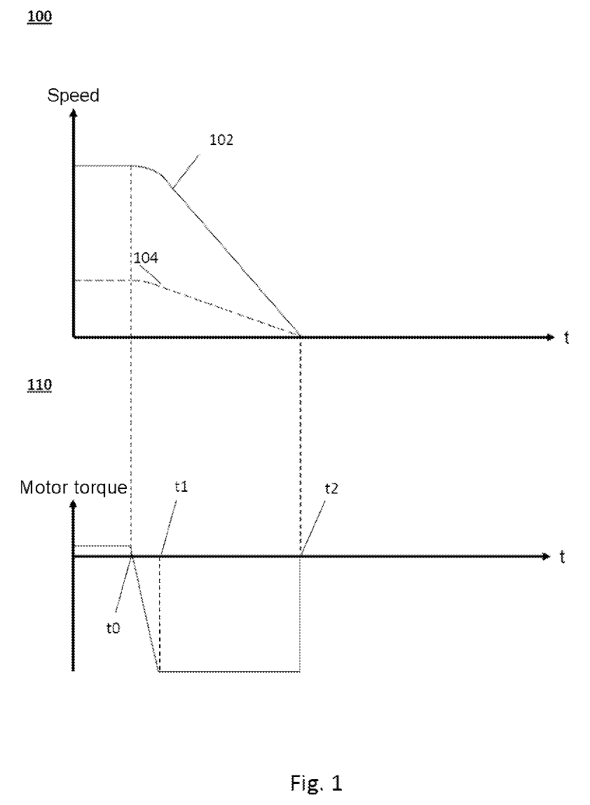

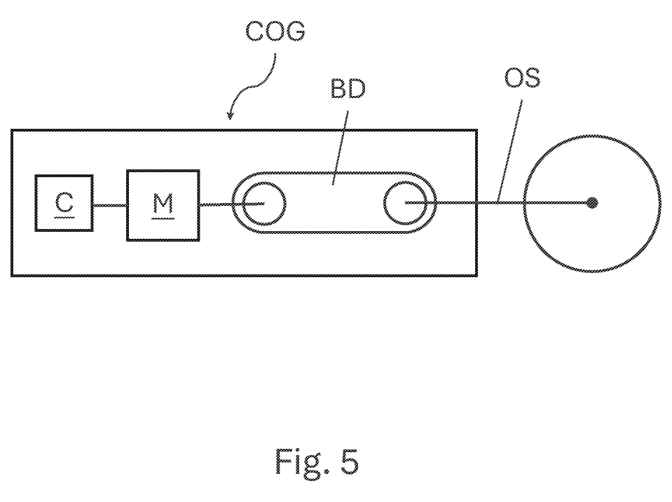

FIG. 1 shows a schematic illustration of a braking operation of a power tool with a belt drive. In particular, the power tool may be a cut-off grinder COG, shown solely schematically in FIG. 5, with a controller C, motor M, belt drive BD and output shaft OS. In the following text, reference is made to a cut-off grinder only by way of example. Of course, however, the present invention is not limited to cut-off grinders, but can be used in particular in any other power tool with a belt drive.

FIG. 1 illustrates a first graph 100, which shows the speed over time. A second graph 110 illustrates the motor torque over time. For one thing, the first graph 100 illustrates the motor speed 102 over time. Moreover, the speed 104 of the cutting disc over time is also apparent from the first graph 100. Only the motor torque is illustrated in the second graph 110. The cut-off grinder is in normal operation up to the time t0, i.e. the motor is operated at a constant speed and with a constant torque. The speed 104 of the cutting disc is also constant up to the time t0. The difference between the motor speed and the speed of the cutting disc exists on account of the transmission ratio in the belt drive. As can be seen in the first graph 100, the cutting disc is operated in particular at a lower speed than the motor.

At the time t0, an active braking operation begins. For example, the active braking operation can be brought about by opposite actuation of the motor. In other words, at the time t0, the motor generates a negative, i.e. a reverse torque. The maximum negative torque is achieved after a short time, at the time t1. As a result of the negative torque, the motor speed is steadily reduced until the motor speed reaches the value of zero, i.e. the motor is at a standstill, at the time t2. In the ideal braking process illustrated in FIG. 1, the speed 104 of the cutting disc follows the motor speed 102 exactly. In other words, the speed 104 of the cutting disc is also reduced steadily until it likewise reaches the value of zero at the time t2. The cutting disc and the rotor thus come to a standstill at the same time t2. On account of the belt drive, however, the drop in the speed of the cutting disc 104 has a lower gradient than is the case for the motor speed 102.

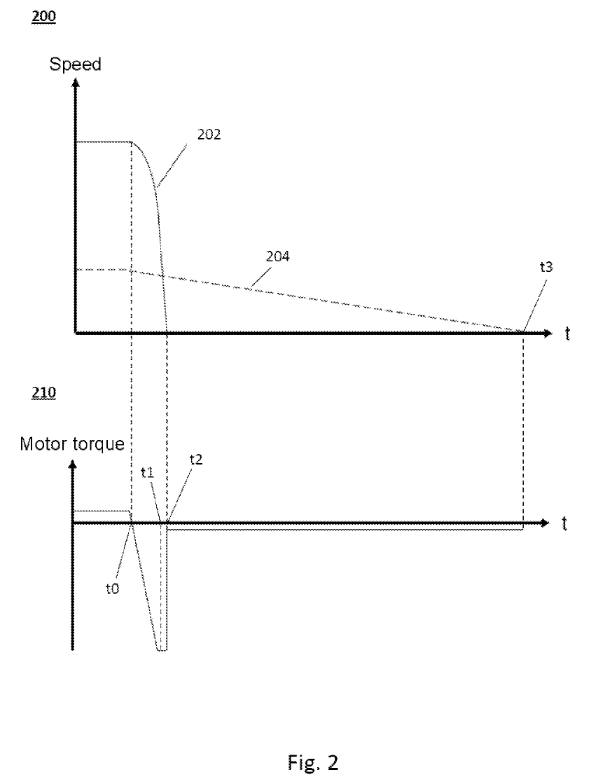

The braking operation illustrated in FIG. 1 is frequently only observed when the braking operation is carried out over a sufficiently long period, i.e. when the braking torque does not become too high. This is because, at a braking torque that is too high, i.e. with an excessive negative acceleration, the belt slips, as is illustrated schematically in FIG. 2. FIG. 2 also illustrates a first graph 200, which shows the speed over time. A second graph 210 shows the motor torque over time. In the scenario shown in FIG. 2, the profile of the speeds of the cutting disc 204 and of the motor 202 is shown when slipping occurs.

In the scenario illustrated in FIG. 2, too, the cut-off grinder is in normal operation up to the time t0, i.e. the motor is operated at a constant speed and with a constant torque. Accordingly, the cutting disc is also operated at a constant speed up to the time t0. At the time t0, an active braking operation again begins. As a result of the active braking, a negative motor torque is generated, which reaches a maximum at the time t1. If the negative torque exceeds the static friction of the belt, the belt slips, i.e. the braking torque is no longer transmitted fully, if at all, to the pulley of the output. In other words, a relative movement occurs between the belt and the pulley connected to the cutting disc. This relative movement is also referred to as slip. At this time, the motor is slowed down independently of the tool, i.e. of the cutting disc. The braking motor torque now only acts counter to the lower motor inertia, and so the motor comes to a standstill more quickly. In the first graph 200 in FIG. 2, the motor standstill is achieved at the time t2. The braking operation for the motor has already ended, while the tool is still moving at a relatively high speed. Only the sliding friction between the pulley of the output and the belt slows down the tool, i.e. the cutting disc, and so the standstill of the cutting disc is achieved much later, specifically at the time t3.

As is immediately apparent from comparing FIGS. 1 and 2, the slipping of the belt results in a considerable lengthening of the braking operation. In particular, the tool comes to a standstill significantly later, with the result that the user’s safety may be put at risk. Therefore, it is an object of the present invention to specify a braking operation for belt drives, which prevents or reduces the slipping of the belt and accordingly significantly reduces the time until the tool is at a standstill.

The present invention is based in principle on the fact that the times in which the belt slips during the braking operation, i.e. the times in which the slip is 100%, are reduced. In particular, this is provided by progressive adjustment of the braking torque. This is intended to have the result that the braking torque does not become too high, or becomes too high only very briefly, in order to prevent or to significantly reduce slip. For example, the braking torque may be applied only at intervals. Alternatively, the strength of the braking torque may be actively regulated. For example, the braking torque may be adjusted on the basis of the slip value.

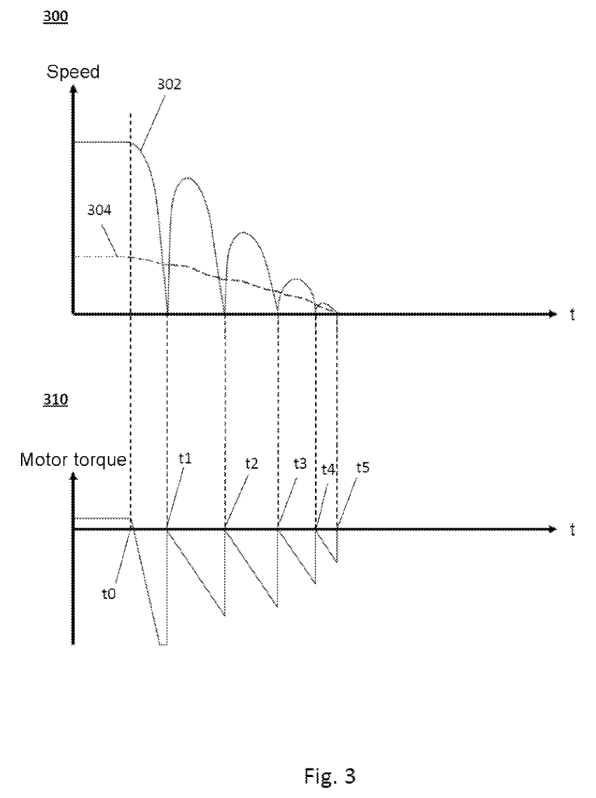

FIG. 3 shows a first braking method according to the invention, in order to reduce the times with high slip. The cut-off grinder is again in normal operation up to the time t0, i.e. the motor speed 302 and the speed of the cutting disc 304 are constant. The motor torque in the second graph 310 is also constant during the first period of time. At the time t0, the braking operation begins. The braking (negative) motor torque is increased until a maximum negative torque has been reached. The motor speed 302 is reduced by this maximum negative torque, until the motor speed 302 is zero, i.e. the motor comes to a standstill at the time t1. The time between t0 and t1 corresponds to a first period of time in which the braking torque is initially increased and, for example after reaching the maximum negative torque, is maintained. During this strong slowing down of the motor, the slip at the belt increases until complete slipping with 100% slip occurs.

As soon as the motor has reached a standstill at the time t1, the first period of time ends. The braking torque, i.e. the negative torque, is returned abruptly to zero in the example according to FIG. 3. For example, for this purpose, speed sensors can be used at the motor. The motor speed 302 is monitored, for example, by a control device. As soon as the motor speed has reached the value of zero, the control device returns the braking torque to zero. In FIG. 3, this occurs immediately, i.e. the braking torque is reduced abruptly to zero at the time t1. This is correct for the target value of the braking torque. In reality, a short time passes until the actual value of the braking torque is set to zero. In the embodiment according to FIG. 3, this time corresponds to the second period of time, during which the braking torque is reduced.

After the second period in time (in FIG. 3 likewise the time t1), the braking torque is slowly increased again. This is apparent from the continuous, negative gradient of the motor torque from the time t1 in the second graph 310. As a result of the interim lower braking torque, the motor speed can converge with the tool speed again, i.e. the slip decreases. It should also be mentioned at this point that, between the times t1 and t2, the speed of the motor 302 also increases again, as is illustrated by the first graph 300. This is particularly the case because, on account of the now reduced slip, the torque of the cutting disc prevailing at the time t1 is transmitted to the motor, with the result that the latter speeds up again. Between the times t1 and t2, the braking torque acts at least temporarily on the cutting disc and the motor again. As soon as the braking motor torque exceeds the static friction of the belt again, increasing slip occurs again. In FIG. 3, this is achieved, for example, half-way through the period of time between t1 and t2. At this time, the motor is slowed down more than the cutting disc by the braking torque. The negative torque is increased by the control device until the motor is again at a standstill at the time t2. The time between t1 and t2 corresponds to a third period of time in which the braking torque is increased, in particular steadily, after it has been set to zero in the second period of time.

The braking torque is reduced again, that is to say returned to zero, at the time t2, i.e. when the speed of the motor reaches zero. At the time t2, too, the cutting disc is not yet at a standstill. The control device identifies that the cutting continues not to be at a standstill (for example by way of a speed measurement of the cutting disc) and again slowly increases the braking torque from the time t2. Shortly after the time t2, the braking torque is still very low, and so the slip again reduces and the braking torque acts both on the cutting disc and on the motor. In the next period of time, too, between the times t2 and t3, the static friction can be exceeded by the braking torque, and so here too the slip increases, or reaches 100%. Accordingly, the control device is configured such that it also continues to set the braking torque to the value of zero as soon as the motor has come to a standstill. If the speed of the cutting disc 304 still continues not to be zero at the time t3, i.e. when the motor has come to a standstill for the third time, the control device again steadily increases the braking torque.

The abovementioned process is repeated until the motor and the cutting disc come to a standstill at the time t5. In other words, in the method according to the invention, the braking torque is periodically increased and reduced. The control device may be designed to increase the braking torque, in each case with a constant gradient, from the time t1, i.e. after the motor has come to a standstill for the first time. In other words, the gradient of the braking torque from the times t1, t2, t3 and t4 may be substantially constant. The gradient, i.e. the speed at which the braking torque is increased, may in this case be defined by the manufacturer of the power tool.

It is apparent from comparing FIGS. 2 and 3 that, as a result of the method according to the invention, the cutting disc comes to a standstill significantly more quickly (times t3 and t5). This is achieved in particular in that the negative motor torque is regularly reduced, in this case dropped to zero, in order to reduce slip at the belt. In FIG. 3, the motor torque is reduced when the motor speed 302 has reached the value of zero.

In alternative embodiment variants that are not illustrated here, the braking torque can also be varied independently of the motor speed. For example, the braking torque can be reduced at predetermined intervals, for example at regular time intervals. For example, the braking torque can be returned to zero every 20 ms. After the braking torque has been set to zero, a control device checks whether the rotating cutting disc is accelerating the motor again. If this is not the case, the control device increases the braking torque steadily for the next 20 ms, i.e. until the braking torque is returned (abruptly) to zero again. If the motor is accelerated again, slip has occurred. The starting value for the braking torque is reduced for the next 20 ms and then steadily increased. The advantage of this embodiment variant is that it is not necessary to wait until the motor speed reaches zero.

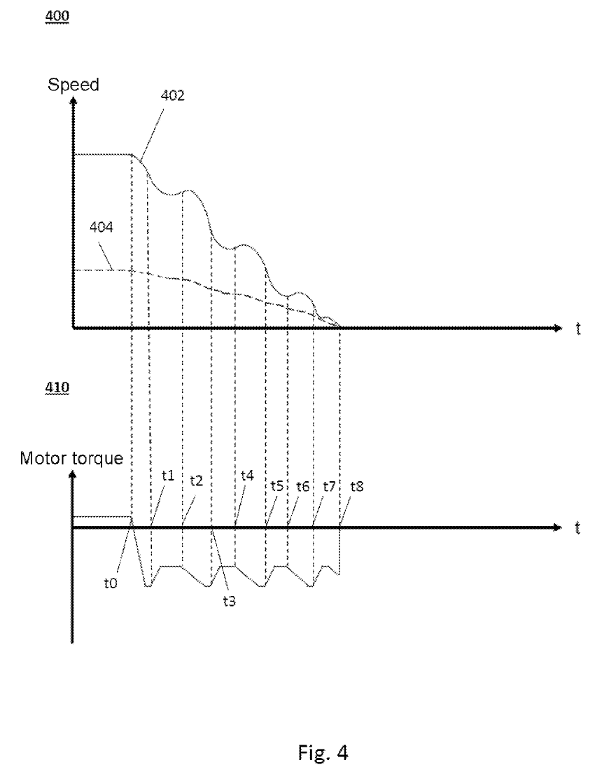

FIG. 4 illustrates a further embodiment of the braking method according to the invention. In this embodiment variant, a control device adjusts the slip occurring at the belt drive. For example, the control device can be designed to keep the slip value below 40%. The slip value results in particular from a quotient between the motor speed 402 and the speed of the cutting disc 404. The control device may, for example, have an algorithm which serves to calculate the slip value.

In FIG. 4, too, the speed of the motor and of the cutting disc over time is illustrated in the first graph 400. In the second graph 410, the motor torque over time is illustrated. The cut-off grinder is in normal operation up to the time t0, i.e. the motor speed 402 and the motor torque are constant. The speed of the cutting disc is also constant up to the time t0.

At the time t0, the braking operation begins. The control device generates a negative torque, i.e. a braking torque which counteracts the drive movement of the motor. The control device may be designed, for example, to steadily increase the braking torque at a suitable, for example predetermined, rate. The control device checks the slip and/or the acceleration of the motor during the increase in the braking torque. As already mentioned above, the control device may, to this end, compare the motor speed 402 with the corresponding speed of the cutting disc 404. The control device can determine the motor speed and the speed of the cutting disc from motor speed data and output speed data, respectively, which may be provided for example by suitable sensors. Alternatively, the speed of the cutting disc can also be estimated on the basis of motor parameters, for example the speed of the motor. The invention is not limited to the manner in which such data are picked up, as long as these are representative of the motor speed and of the speed of the cutting disc, respectively.

If the control device determines that the slip value has dropped below a definable limit value, for example 40%, the control device prevents the braking torque from increasing further. In FIG. 4, the slip value is achieved at the time t1. The time between t0 and t1 corresponds to a first period of time in which the braking torque is initially increased and then maintained. In order to reduce the slip value, the control device reduces the braking torque at the time t1 until the slip value drops below the limit value of, for example, 40% again. The control device may be designed to interrupt the reduction in the braking torque when the slip value has dropped below the limit value. As is apparent from the second graph 410 in FIG. 4, the braking torque reduced in this way can be kept constant for a certain period of time, such that a further reduction in the slip value occurs. At a time t2, i.e. when the slip value drops below the desired limit value, the control device increases the braking torque once again. The period of time between t1 and t2 corresponds to the second period of time, in which the braking torque is reduced. This operation is continued in the example according to FIG. 4 until both the motor and the cutting disc come to a standstill at the time t8. In particular, the control device increases the braking torque at the times t4 and t6, while the braking torque is reduced at the times t3, t5 and t7.

The adjustment to the desired slip according to FIG. 4 is thus achieved in that the braking motor torque is continuously adapted. In the case of excessive slip, the braking (negative) motor torque is reduced, and the slip is reduced as a result. If the slip becomes lower, the braking (negative) torque is increased again. As a result, the braking time of the cutting disc is substantially reduced once again. Compared with FIG. 3, according to FIG. 4, the motor only comes to a standstill when the cutting disc also comes to a standstill. In other words, the cutting disc and the motor both come to a standstill at the same time only at the time t8. By contrast, according to the embodiment in FIG. 3, the motor comes to a standstill multiple times before the cutting disc also comes to a standstill.

In an alternative embodiment variant, the slip (or excessive slip) can also be determined on the basis of an increase in the motor speed. As is known, the increase in the motor speed is the acceleration of the motor. Should the negative acceleration, i.e. the slowing down of the motor, become too quick, it can be assumed that slip has occurred. A control device can accordingly be designed to sense the motor acceleration and to compare this with an acceleration limit value. The acceleration limit value may be defined, for example, by the manufacturer.

The acceleration limit value is determined primarily by way of the inertia of the cutting disc, since the torque of the cutting disc can, for physical reasons, not be slowed down to a standstill at any desired speed. In general, it is the case that the period of time until the cutting disc has been completely slowed down is a function of the inertia and of the maximum braking torque. Without slip, the entire braking torque of the motor is transmitted to the cutting disc. It is possible to calculate or estimate how long the cutting disc requires, at maximum motor braking torque, in order to come to a standstill. On the basis of the expected period of time until the cutting disc is braked, it is possible to determine how high the braking acceleration, i.e. negative acceleration, of the motor can be at a maximum, since this is slowed down over the same period of time as the cutting disc in the absence of slip (cf. FIG. 1).

However, when slip occurs, it is possible for the braking torque to act only (or primarily) on the motor and thus a lower inertia needs to be slowed down. The consequence is a much higher braking acceleration of the motor than is to be expected in the system with a cutting disc. The acceleration limit value may be defined as a motor acceleration which is faster than would be expected with the inertia of the cutting disc. Should the negative acceleration of the motor exceed this acceleration limit value, the control device assumes the occurrence of slip and begins to reduce the braking torque. The braking torque can be reduced until the negative motor acceleration slows down sufficiently again, for example drops below a second acceleration limit value, or until the motor acceleration reaches the value of 0. Then, the control device can either maintain the braking torque or increase it again.

The present invention is not limited to the embodiments shown in the figures, but results from a combination of all the features disclosed herein.

### LIST OF REFERENCE SIGNS

100, 200, 300, 400 First graph

102, 202, 302, 402 Motor speed

104, 204, 304, 404 Speed of cutting disc

110, 210, 310, 410 Second graph

t1, t2, t3, t4, t5, t6, t7, t8 Time

C Controller

M Motor

BD Belt Drive

OS Output shaft

What is claimed is:

1. A method for braking a power tool, wherein the power tool has a motor connected to an output shaft via a belt drive, the method comprising the following steps:
applying or maintaining a braking torque, acting on the motor, for a first period of time;
reducing the braking torque for a second period of time; and
increasing or maintaining the braking torque for a third period of time.

2. The method as recited in claim 1, wherein the braking torque is achieved by way of a negative torque.

3. The method as recited in claim 1, further comprising a step of sensing motor speed data representative of a speed of the motor, and wherein an end of the first period of time or of the third period of time is determined on the basis of the motor speed data.

4. The method as recited in claim 1, wherein an end of the first or of the third period of time is reached when the speed of the motor is zero.

5. The method as recited in claim 1, wherein the second period of time is zero.

6. The method as recited in claim 1, wherein after step c), steps b) and c) are repeated.

7. The method as recited in claim 1, wherein after step c), steps b) and c) are repeated until the output shaft comes to a standstill.

8. The method as recited in claim 1, wherein the first, second or third time period are predetermined time intervals.

9. The method as recited in claim 1, further comprising the following steps:
sensing motor speed data representative of a speed of the motor;
sensing/estimating output speed data representative of a speed of the output shaft;
determining the speed of the motor and the speed of the output shaft;
determining a slip value on the basis of the speed of the motor compared with the speed of the output shaft;
increasing or reducing the braking torque on the basis of the slip value.

10. The method as recited in claim 9, wherein the length of the first, of the second and of the third time interval is adjusted such that the slip value falls in a predetermined range of values.

11. The method as recited in claim 9, wherein the periods of time are adjusted such that the slip value is between 0% and 40%, preferably between 0% and 30%.

12. The method as recited in claim 9, wherein the periods of time are adjusted such that the slip value is between 0% and 30%.

13. The method as recited in claim 2, wherein the braking torque is maximized during the first period of time.

14. A power tool comprising: a motor and an output shaft driven via a belt drive, wherein the power tool has a controller carrying out the method as recited in claim 1.

15. The power tool as recited in claim 14, wherein the power tool is a cut-off grinder.

16. A computer program comprising instructions which, when the program is executed by a controller, cause the latter to carry out the method as recited in claim 1.

17. The method as recited in claim 1, further comprising the following steps:
sensing motor speed data representative of a speed of the motor;
determining the acceleration of the motor on the basis of the motor speed data;
comparing the acceleration of the motor with an acceleration limit value; and
reducing or increasing the braking torque on the basis of the comparison.
